(19) United States
(12) Patent Application Publication
(10) Pub. No.: US 2006/0105076 A1
(43) Pub. Date: May 18, 2006

(54) Molding apparatus

(76) Inventors: James O. Adas, Clinton Township, MI (US); Michael S. Kreitner, Grand Rapids, MI (US)

Correspondence Address: MILACRON INC., 2090 FLORENCE AVE., CINCINNATI, OH, 45206, US

(21) Appl. No.: 10/991,142

(22) Filed: Nov. 17, 2004

(51) Int. Cl. B29C 35/00

(52) U.S. Cl. 425/444

(57) ABSTRACT

A mold assembly for a molding machine having an ejector device member operatively engagable with ejector device elements of the mold assembly comprises a subassembly for retaining a mold component, the sub-assembly having an opening therein wherein a movable ejector assembly comprising at least one ejector pin is contained and comprising a mounting plate for mounting the sub-assembly to the molding machine, the mounting plate having an opening therein open to the periphery of the mounting plate at one edge thereof for providing clearance for the molding machine ejector device member; a collar being open to one side and having a capture cavity comprising the opening therein; and a capture element for operative engagement with the collar, wherein one of the movable ejector assembly and the molding machine ejector device member comprises the collar and the other comprises the capture element.

### BACKGROUND OF THE INVENTION

1. Field of the Invention

This invention relates generally to molding. In particular, this invention relates to mold assemblies having ejector devices.

2. Description of Related Art

It is known in the art of molding, for example injection molding, to use mold assemblies comprising mounting sub-assemblies constructed for mounting to members of a molding machine and carrying mating mold components defining one or more mold cavities. Mounting sub-assemblies are advantageously constructed to permit ease of installation and removal of mold assemblies in a press of a molding machine. In addition to the mating mold components, mold assemblies advantageously comprise elements of ejector devices for dislodging molded material from the mating mold components. It is known to provide mounting sub-assemblies that include elements of an ejector device carried therein. Translation of mounting sub-assemblies for installation and removal from a molding machine press is substantially transverse to the direction of movement of ejector device elements. With known mounting sub-assemblies, ejector device members of the molding machine press must pass through elements of the mounting sub-assembly. Hence, connection of the ejector device elements carried by the mounting sub-assembly with associated ejector device elements comprising the machine press, requires mechanical joining by fasteners or threaded members. Such connections add to the effort required for installation and removal of the mounting sub-assemblies. Hence, there is a need for a mounting sub-assembly that reduces the effort required to join ejector device elements carried by the mounting sub-assembly with associated ejector device elements comprising a molding machine press.

### SUMMARY OF THE INVENTION

It is an object of the present invention to provide a mold assembly for a molding machine having an ejector device member operatively engagable with ejector device elements of the mold assembly wherein the ejector device member is engaged with the ejector device elements of the mold assembly by engagement of a capture element and a collar.

It is a further object of the present invention to provide a mold assembly for a molding machine having an ejector device member operatively engagable with ejector device elements of the mold assembly, the mold assembly comprising a sub-assembly having an opening therein wherein is contained a movable ejector assembly comprising at least one ejector pin; a collar being open to one side and having a capture cavity comprising the opening therein; and a capture element for operative engagement with the collar, wherein one of the movable ejector assembly and the molding machine ejector device member comprises the collar and the other comprises the capture element.

Further objects and advantages of the invention shall be made apparent from the accompanying drawings and the following description thereof.

In accordance with the aforesaid objects the present invention provides a mold assembly for a molding machine having an ejector device member operatively engagable with ejector device elements of the mold assembly, the mold assembly comprising a sub-assembly for retaining a mold component, the sub-assembly having an opening therein wherein a movable ejector assembly comprising at least one ejector pin is contained and comprising a mounting plate for mounting the sub-assembly to the molding machine, the mounting plate having an opening therein open to the periphery of the mounting plate at one edge thereof for providing clearance for the molding machine ejector device member; a collar being open to one side and having a capture cavity comprising the opening therein; and a capture element for operative engagement with the collar, wherein one of the movable ejector assembly and the molding machine ejector device member comprises the collar and the other comprises the capture element.

### BRIEF DESCRIPTION OF THE DRAWINGS

FIG. 1 is a three dimensional view of a mounting sub-assembly revealing ejector device elements carried thereby and engagement of an ejector rod with an ejector rod retainer in accordance with the invention.

FIG. 2 is a bottom view of the mounting sub-assembly of FIG. 1 with an ejector rod engaged and a mold component mounted to a die mounting plate.

FIG. 3 is a front view of the mounting sub-assembly of FIG. 1 with the mounting plate removed showing an ejector rod retainer in accordance with the invention.

### DETAILED DESCRIPTION OF THE PREFERRED EMBODIMENT

The invention shall be illustrated with reference to a preferred embodiment which shall be described in detail. It is not the intention of applicants that the invention be limited to the preferred embodiment, but rather that the invention shall be defined by the appended claims and all equivalents thereof.

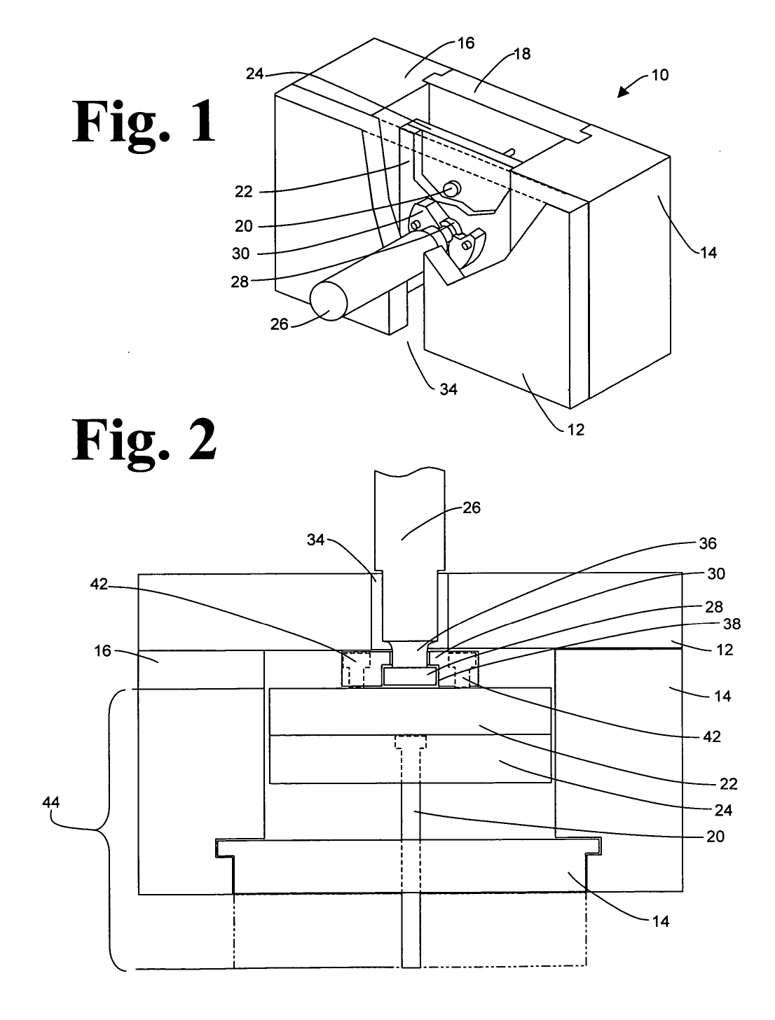

Referring to FIG. 1, a mold sub-assembly 10 comprises a mounting plate 12, right and left side die retention plates 14 and 16, respectively, and a die mounting plate 18 for supporting a mold component. Left and right side die retention plates space die mounting plate 18 from mounting plate 12. Advantageously, left and right side retention plates have grooves for receiving projecting ears of die mounting plate 18 facilitating removal and insertion of die mounting plates with mold components attached. Elements of an ejector device are movably supported within the opening created by mounting plate 12, die retention plates 14 and 16 and die mounting plate 18, the opening referred to herein as an “ejector box”. Mounting plate 12 is shown with a partial cut-away revealing elements within the interior of the ejector box.

Referring to FIGS. 1 and 2, ejector device elements within the ejector box comprise a movable ejector assembly 44 comprising ejector pins, such as ejector pin 20, and ejector plate 24 for supporting ejector pins. The movable ejector assembly advantageously further comprises pin retainer plate 22 attached to ejector plate 24 for retaining ejector pins supported thereby. As shown, ejector pins have a head end and a projecting portion, the head end is held captive by attachment of pin retainer plate 22 to ejector plate 24. Ejector pins may alternatively be attached to ejector plate 24 by, for example a threaded connection between an ejector pin and ejector plate 24 or a threaded element attached thereto. Projecting ends of the ejector pins pass through die mounting plate 18 and protrude into a mold component mounted thereto (shown in phantom in FIG. 2). Movement of ejector plate 24 toward die mounting plate 18 advances the projecting ends of the ejector pins to dislodge a molded article and sprue from the mold component mounted thereto. Movement of ejector plate 24 away from die mounting plate 18 retracts the projecting ends of the ejector pins to a position wherein the extremity thereof lies flush with a molding surface of the mold component. Hence, the ejector device operates to reciprocate ejector pins toward and away from die mounting plate 18. Installation and removal of the sub-assembly 10 from a molding machine press requires translation thereof in a direction substantially transverse to the direction of reciprocation of ejector plate 24.

Continuing with reference to FIGS. 1 and 2, mounting plate 12 has an opening 34 therein open to the periphery at one edge thereof is otherwise substantially closed at its periphery (illustrated by dashed lines at the top of the partial cut-away shown in FIG. 1). Opening 34 provides clearance for an ejector rod 26 comprising an element of the ejector device that is part of a molding machine press. Ejector rod 26 passes through opening 34 for operative engagement with retainer plate 22. Reciprocation of ejector plate 24 is effected by reciprocation of ejector rod 26 by a drive (not shown) comprising the ejector device. Ejector rod 26 comprises a capture end 28 for engagement with horseshoe collar 30 mounted to retainer plate 22. Capture end 28 and horseshoe collar 30 are designed to permit engagement of ejector rod 26 with pin retainer plate 22 (and hence with ejector plate 24) without necessity of removal or installation of fasteners or engagement of threaded members. Although capture end 28 is illustrated as comprising ejector rod 26, a capture member could alternatively be provided on retainer plate 22 and an engaging collar fitted to ejector rod 26.

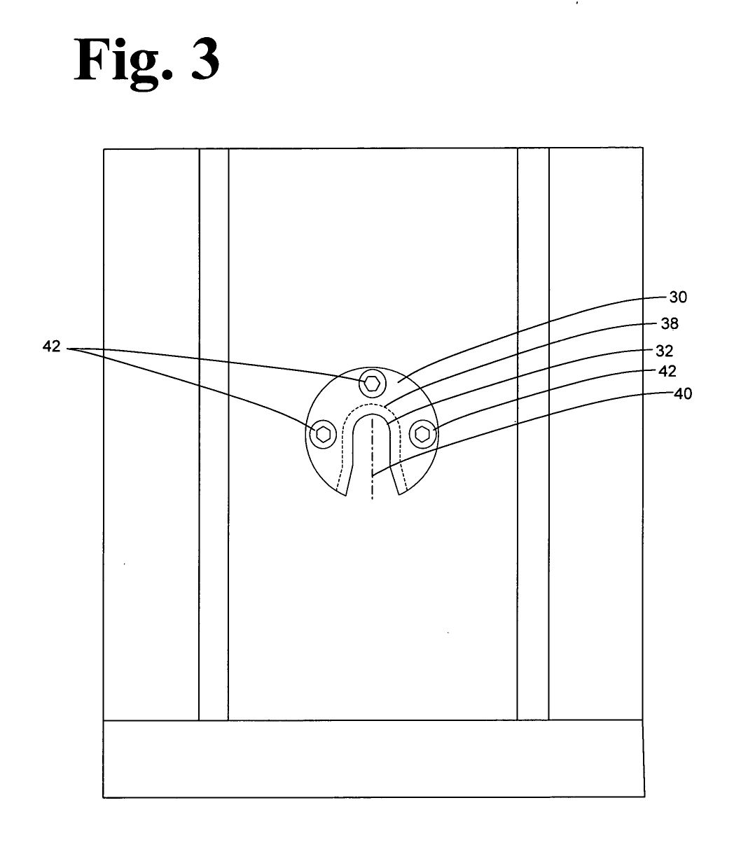

Referring to FIGS. 2 and 3, horseshoe collar 30 is attached to retainer plate 22 by fasteners such as screws 42. Were there no retainer plate, horseshoe collar 30 would be attached to ejector plate 24. As seen in FIG. 3, horseshoe collar 30 is open to one side thereof and is otherwise substantially closed at its periphery. The open side of collar 32 comprises opening 32 providing clearance for neck 36 of ejector rod 26 and capture cavity 38 providing clearance for capture end 28. Operative engagement of ejector rod 26 with pin retainer plate 22 is effected by horseshoe collar 30 holding capture end 28 within capture cavity 38. The direction of reciprocal motion of ejector rod 26 is along the longitudinal axis thereof. Reciprocation of ejector rod 26 effects reciprocation of ejector plate 24 toward and away from die mounting plate 18 by operative engagement of capture end 28 with horseshoe collar 30.

Referring to FIG. 1, installation of sub-assembly 10 in a molding machine press advantageously is effected by translation of sub-assembly 10 to permit projecting ejector rod 26 to enter mounting plate 12 through opening 34 and to permit capture end 28 to enter capture cavity 38 of horseshoe collar 30. Referring to FIG. 3, openings 32 and 34 are open to the same side of sub-assembly 10 permitting translation of retainer plate 22 and mounting plate 12, respectively, relative to ejector rod 26 along the central axis 40 of opening 32. With capture end 28 positioned within capture cavity 38, operative engagement of ejector rod 26 with the moveable ejector assembly is effected without necessity of insertion of any fasteners or threading engagement of any connecting means therebetween. In an arrangement wherein a capture element comprises movable ejector assembly 44 and ejector rod 26 comprises an engaging collar, the opening of the collar and the opening of mounting plate 12 would face opposite sides of sub-assembly 10 to allow entry of the capture element into the collar by translation of the sub-assembly relative to ejector rod 26.

What is claimed is:

1. A mold assembly for a molding machine having an ejector device member operatively engagable with ejector device elements of the mold assembly, the mold assembly comprising:
a) a sub-assembly for retaining a mold component, the sub-assembly having an opening therein wherein a movable ejector assembly comprising at least one ejector pin is contained and comprising a mounting plate for mounting the sub-assembly to the molding machine, the mounting plate having an opening therein open to the periphery of the mounting plate at one edge thereof for providing clearance for the molding machine ejector device member;
b) a collar being open to one side and having a capture cavity comprising the opening therein; and
c) a capture element for operative engagement with the collar, wherein one of the movable ejector assembly and the molding machine ejector device member comprises the collar and the other comprises the capture element.

2. The mold assembly according to claim 1 wherein the molding machine ejector device member comprises the capture element and the openings in the mounting plate and collar are open to the same side of the sub-assembly.

3. The mold assembly according to claim 1 wherein the molding machine ejector device member comprises the collar and the mounting plate and collar are open to opposite sides of the sub-assembly.

4. The mold assembly according to claim 1 wherein the molding machine ejector device member comprises an ejector rod and the movable ejector assembly comprises an ejector plate supporting at least one ejector pin.

5. The mold assembly of claim 4 wherein the movable ejector assembly further comprises a pin retainer plate attached to the ejector plate for retaining ejector pins supported by the ejector plate.

6. A mold assembly for a molding machine having an ejector device member comprising an ejector rod operatively engagable with an ejector assembly comprising ejector pins of the mold assembly, the mold assembly comprising:
a) a sub-assembly for retaining a mold component, the sub-assembly having an opening therein wherein the ejector assembly is contained and comprising a mounting plate for mounting the sub-assembly to the molding machine, the mounting plate having an opening therein that is open to one side of the mounting plate;
b) a collar being open to one side and having a capture cavity comprising the opening therein; and
c) a capture element for operative engagement with the collar, wherein one of the movable ejector assembly and the molding machine ejector device member comprises the collar and the other comprises the capture element.

7. The mold assembly according to claim 6 wherein the ejector rod comprises the capture element and the mounting plate and collar are open to the same side.

8. The mold assembly according to claim 6 wherein the movable ejector assembly comprises the capture element and the mounting plate and collar are open to opposite sides.

9. The mold assembly according to claim 6 wherein the movable ejector assembly comprises an ejector plate supporting at least one ejector pin.

10. The mold assembly of claim 9 wherein the movable ejector assembly further comprises a pin retainer plate attached to the ejector plate for retaining ejector pins supported thereby.
